(19) United States
(12) Patent Application Publication
(10) Pub. No.: US 2015/0292894 A1
(43) Pub. Date: Oct. 15, 2015

(54) TRAVEL ROUTE

(71) Applicants: Mark Goddard, Rancho Santa Margarita, CA (US); Gordon John Hines, Kirkland, WA (US); Timothy James Lorello, Gambrills, MD (US); Drew A. Morin, Davidsonville, MD (US); Gangadhar Arkalgud Ramesh, Greenbelt, MD (US); Anna Rosemarie Thomas, Gibsonton, FL (US)

(72) Inventors: Mark Goddard, Rancho Santa Margarita, CA (US); Gordon John Hines, Kirkland, WA (US); Timothy James Lorello, Gambrills, MD (US); Drew A. Morin, Davidsonville, MD (US); Gangadhar Arkalgud Ramesh, Greenbelt, MD (US); Anna Rosemarie Thomas, Gibsonton, FL (US)

(73) Assignee: TELECOMMUNICATION SYSTEMS, INC., Annapolis, MD (US)

(21) Appl. No.: 14/683,633

(22) Filed: Apr. 10, 2015

Related U.S. Application Data
(60) Provisional application No. 61/978,675, filed on Apr. 11, 2014.

(51) Int. Cl. G01C 21/34

(52) U.S. Cl. CPC G01C 21/34

(57) ABSTRACT

A route engine can be configured to receive route data that characterizes a request for driving directions to a destination. The route engine can also be configured to determine a plurality of travel routes to the destination and to estimate a predicted travel time for each of the plurality of travel routes to the destination. The estimation can be based on environmental data that characterizes environmental conditions that affect traffic flow along the plurality of travel routes. The route engine can further include determining a likelihood that each predicted travel time for each of the plurality of travel routes is accurate.

### CROSS-REFERENCE TO RELATED APPLICATION

This application claims the benefit of priority to U.S. Provisional Application No. 61/978,675, filed on Apr. 11, 2014, and entitled NAVIGATION SYSTEM, the entirety of which is herein incorporated by reference.

### TECHNICAL FIELD

This disclosure relates to a route engine that determines a travel route.

### BACKGROUND

A position tracking device is a device that can employ a Global Navigation Satellite System (GNSS), such as the Global Positioning System (GPS), GLONASS and/or other system such as a wireless carrier network to determine a precise location of a vehicle, person or other asset to which the position tracking device is attached to and/or located in and to record the position of the asset at regular intervals. The recorded location data can be stored within the position tracking unit, or recorded location data may be transmitted to a central location database or an internet-connected computer, using a cellular data connection such as the general packet radio service (GPRS) (e.g., a 2G or 3G data network), a 4G Long Term Evolution (LTE) network, Short Message Service (SMS), radio or satellite modem embedded in the position tracking device, etc. This allows the asset's location to be displayed against a map backdrop either in real time or when analyzing the track later, using tracking software. Position tracking software (e.g., a navigation application) is available for smartphones and other end-user devices, such that an end-user device executing a navigation application can operate as a position tracking device.

A Knowledge-based system is a computer program that reasons and uses a knowledge base to solve complex problems. The term knowledge-based system is broadly used to refer to many different kinds of systems. Knowledge-based systems represent knowledge explicitly via tools such as ontologies and rules rather than implicitly via code the way a conventional computer program does. A knowledge-based system has at least one and usually two types of sub-systems: a knowledge base and an inference engine. The knowledge base represents facts about the world. The inference engine represents logical assertions and conditions about the world, usually represented via IF-THEN rules.

### SUMMARY

One example relates to a non-transitory machine readable medium having machine executable instructions comprising a route engine, the route engine can be configured to receive route data that characterizes a request for driving directions to a destination. The route engine can also be configured to determine a plurality of travel routes to the destination and estimate a predicted travel time for each of the plurality of travel routes to the destination. The estimation can be based on predictive influences derived from environmental data that characterizes environmental conditions that affect traffic flow along the plurality of travel routes. The route engine can further be configured to determine a likelihood that each predicted travel time for each of the plurality of travel routes is accurate.

Another example relates to a knowledge-based system comprising one or more computing devices. The knowledge-based system can be configured to determine a travel route from a current location of an end-user device to a destination. The knowledge-based system can also be configured to determine a minimum travel time for the travel route based on a distance of the travel route and on speed limits of roads along the travel route. The knowledge-based system can further be configured to estimate a predicted travel time for the travel route based on the minimum travel and predictive influences derived from environmental data that characterizes environmental conditions affecting traffic flow along roads of the travel route. The knowledge-based system can yet further be configured to provide route data that characterizes the travel route to a navigation application executing on the end-user device.

Yet another example relates to a method that can include determining a plurality of travel routes to a destination in response to a route request. The method can also include determining a minimum travel time for each of the plurality of travel routes and estimating a predicted travel time for each of the plurality of travel routes based on predictive influences derived from environmental data that characterizes environmental conditions affecting the travel time. The method can further include determining a likelihood that each predicted travel time for the plurality of travel times is accurate.

### BRIEF DESCRIPTION OF THE DRAWINGS

FIG. 1 illustrates an example of a system to determine a travel route.

FIG. 2 illustrates an example of a screen shot output at an end-user device.

FIG. 3 illustrates a screen shot of a graphical user interface for selecting user preferences.

FIG. 4 illustrates an example of a knowledge-based system.

FIG. 5 illustrates an example of input data for a route request.

FIG. 6 illustrates another example of input data for a route request.

FIG. 7 illustrates yet another example of input data for a route request.

FIG. 8 illustrates a flowchart of an example method of determining a travel route.

FIG. 9 illustrates an example of a route engine to implement a knowledge based system.

### DETAILED DESCRIPTION

Systems and methods are described herein for determining a travel route (e.g., driving directions) for a navigation application executing on an end-user device. The travel route can be determined by a route engine of a knowledge-based system. Additionally, the route engine can estimate a predicted travel time for the travel route. The predicted travel time can be based, for example, on environmental data that characterizes environmental conditions affecting travel (e.g., traffic, weather, crime, community events, etc.). To estimate the predicted travel time, the route engine can employ an inference engine (e.g., artificial intelligence) that can weigh each environmental condition to facilitate estimation of the predicted travel time to the destination.

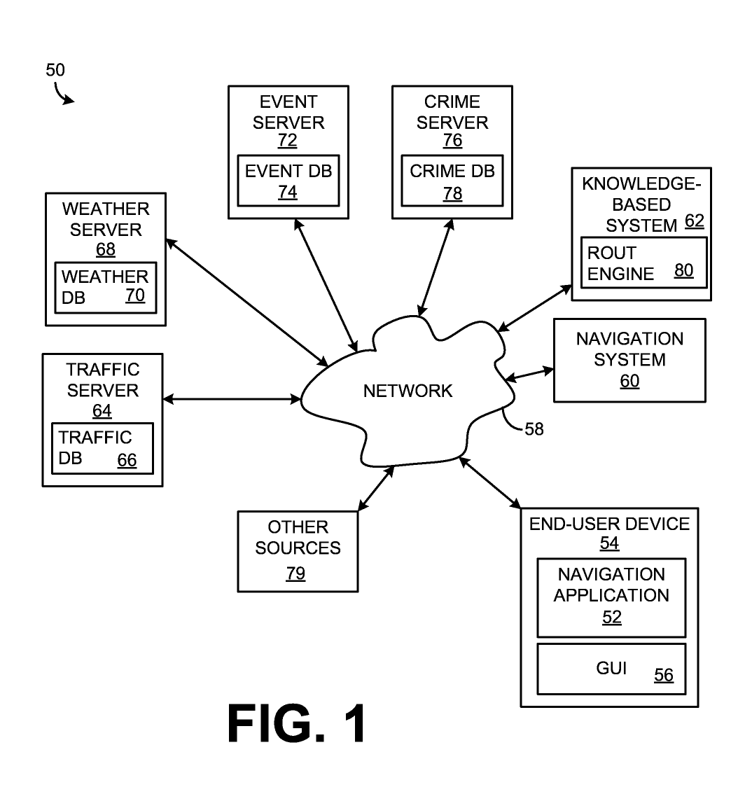

FIG. 1 illustrates an example of a system 50 that could be employed to implement a navigation application 52 that executes on an end-user device 54. The end-user device 54 could be a mobile device (e.g., user equipment). For example, the end-user device 54 can be a standalone GPS navigation module. In other examples, the end-user device 54 could be a general purpose computer, such as a smart phone, a tablet computer, etc. The end-user device 54 can include a processing unit (e.g., that includes a processor core) to execute machine readable instructions. The mobile device 6 can also include a non-transitory machine readable medium, such as memory (volatile and/or non-volatile) that is accessible by the processor. The memory can be employed to store the machine readable instructions. In some examples, the end-user device 54 can be integrated with a control system of an autonomous vehicle.

The end-user device 54 can include the navigation application 52 stored in the memory of the end-user device 54. In some examples, the navigation application 52 can be implemented as application software (e.g., an App) executing on the end-user device 54. The navigation application 52 can receive satellite signals that are employable to derive location coordinates (e.g., location information) for the end-user device 54. In other examples, the navigation application 52 can derive the location of the end-user device 54 in different ways (e.g., triangulation). The end-user device 54 can include a graphical user interface (GUI) 56 that can include a touch screen or other user input mechanism that can allow a user to view a map depicting a current position of the end-user device 54.

The GUI 56 of the end-user device 54 can provide an interface that allows a user to select a travel route between a starting position (e.g., a current location or other location) and a destination location. In some examples, the user can provide user input that characterizes an address or other location information (e.g., GPS coordinates) of the starting position and/or destination. In some situations, the user input can be text, speech that is converted to text or a combination thereof.

The end-user device 54 can be coupled to a network 58. The network 58 can include for example, a wireless network, a wired network or a combination thereof. The network 58 can be implemented as a public network (e.g., the Internet), a private network (e.g., a wireless subscriber network) or a combination thereof. The navigation application 52 can communicate with a navigation system 60 via the network 58. The navigation system 60 can be implemented as a server. In some examples, the navigation system 60 could be implemented in a computing cloud. In other examples, the navigation system 60 can be implemented as a stand-alone server.

The navigation application 52 can provide the navigation system 60 a route request for a travel route from the starting position (e.g., the current location of the end-user device 54) to the destination. In some situations, the route request can include a request for multiple stops and an associated priority weight (e.g., urgency of time of arrival at a particular destination at a particular time). Additionally, in some examples, the route request can include a list of user preferences that characterize preferred driving conditions of the user. The navigation system 60 can forward the route request including the data characterizing the starting position to a knowledge-based system 62 via the network 58. Moreover, in some situations, the navigation system 60 can convert the route request into a format understandable by the knowledge-based system 62.

The knowledge-based system 62 can be implemented, for example, as an artificial intelligence system that can process natural language, such as the IBM Watson® system. In other examples, the knowledge-based system 62 can be implemented as a belief network (e.g., a Bayesian network), a decision tree, an ensemble learning algorithm (e.g., a random forest), a neural network, logistical regression, a support vector machine, a naive Bayes classifier, a combination thereof, etc.

The knowledge-based system 62 can employ an inference engine to process the route request to determine a given area between and/or around the starting position and the destination. The knowledge-based system 62 can be configured to query and receive environmental data for the given area from a plurality of sources via the network 58. The environmental data can characterize environmental conditions that can affect traffic flow for an area. In some examples, the road segmentation data can be implemented as natural language text (e.g., English text), structured data statistical data or a combination thereof. In some instances, some data could be converted to a form (e.g., natural language text) employable by the knowledge-based system 62.

In some examples, the plurality of sources can be feeds of data from multiple sources or a single feed of data from a single source. However, for purposes of simplification of explanation, the sources are described herein as being provided from a plurality of servers. For instance, the plurality of sources can include, a traffic server 64 that can include a traffic database (DB) 66, and the traffic server 64 can be configured to provide the knowledge-based system 62 with data that represents historical traffic and/or real-time traffic data characterizing traffic patterns for roads in the given area. In such a situation, the historical traffic data can characterize historical accident and/or historical traffic volume for each road in the given area for a given time of day, a given day of the week or a given day of a year.

Additionally, a weather server 68 that includes a weather database 70 can be configured to provide historical and real-time weather data to the knowledge-based system 62. The weather data can characterize current weather patterns, past weather patterns and/or predictive weather patterns for the given area. For instance, the weather data could indicate real and/or predictive weather (e.g., comfortable, sunny/hot, snow/cloud, raining, windy, etc.). Further, an event server 72 that includes an event database 74 can be configured to provide event data to the knowledge-based system 62. The event data can characterize a date, time and nature of community events (e.g., social events) in the given area. Such community events can include, for instance, sporting events, concerts, plays, etc. Still further, a crime server 76 can include a crime database 78 that provides historical and/or real-time crime data to the knowledge-based system. The crime data can include historical information about crime in the given area (e.g., a crime rate) as well as data characterizing known places where a crime is currently being committed and/or recently occurred, as well as the type of crime committed (e.g., carjacking, robbery, domestic violence, etc.).

It is noted that in some examples, one or more of the traffic server 64, the weather server 68, the event server 72 and the crime server 76 can be integrated together. However, for purposes of simplification of explanation, these servers are illustrated as being implemented as separate entities. The knowledge-based system 62 can also receive data from other sources 79 (e.g., other data feeds), such as social networks, news feeds, etc.

The knowledge-based system 62 can process the route request to determine a plurality of travel routes and a distance for each travel route between the starting position and the destination. Each of the travel routes can be within the given area. The travel routes can characterize, for example, a series of roads that lead from the starting position to the destination. Additionally, the knowledge-based system 62 can determine a minimum time to travel each of the plurality of travel routes. The minimum time can characterize the minimum time needed to legally travel (e.g., drive within speed limits) between the starting position and the destination during optimal (or near optimal conditions) (e.g., good weather, light traffic, etc.).

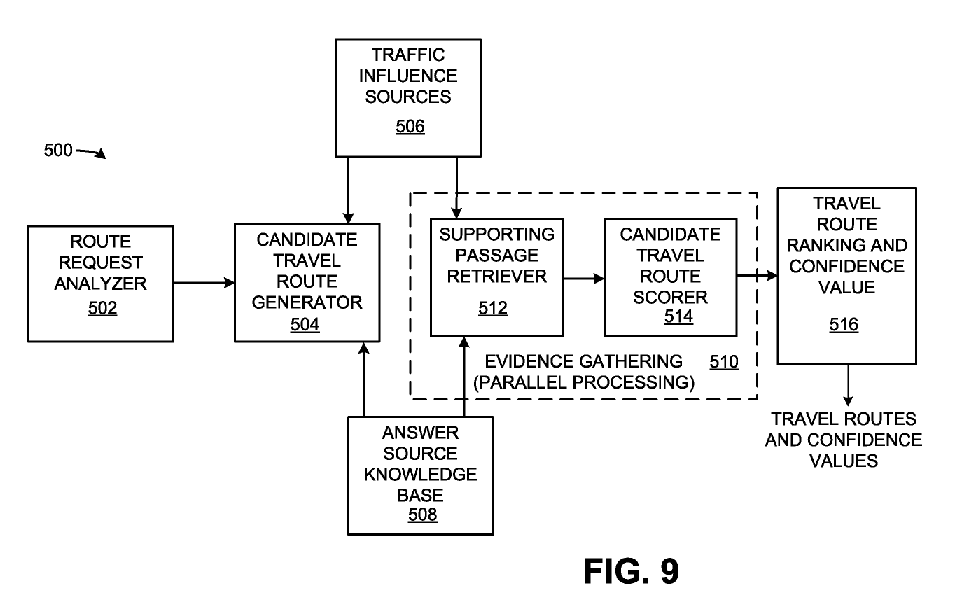

The knowledge-based system 62 can include a route engine 80 (e.g., an artificial intelligence engine) that can employ an inference engine (or other intelligence engine) to aggregate the traffic data, the weather data, the event data, the crime data and/or to estimate a predicted travel time for each of the plurality of travel routes. The predicted travel time can represent, for example a travel time that accounts for predictive influences of traffic patterns, weather, local events etc. To estimate the predicted travel time, the route engine 80 can employ, for example, a weighted function with parameters related to the predictive influences. For instance, the predicted travel time of a travel route can be based on the minimum travel time plus delays that account for predictive influences derived from environmental data that characterizes environmental conditions that affect traffic flow. The knowledge based system 62 and/or the route engine 80 can be implemented in a manner shown and described in FIG. 9.

The predictive influences can cause predictable delays of traffic flow, predictable hazards and/or predictable avoidance areas along a given travel route of the plurality of travel routes. For instance, historical and/or real-time accident and/or traffic volume characterized by the traffic data can be employed by the route engine 80 to determine predictable delay times caused by traffic for times near the time that the travel route request is provided by the navigation system 4. Additionally, the route engine 80 can employ the event data to determine predictable delays related to a given community event. For instance, the route engine 80 can predict delays caused by an increase in traffic volume for time period leading up to the given community event. Additionally, the route engine 80 can predict hazards caused by people that are running late to the given event (e.g., due to speeding). Furthermore, the route engine 80 can predict delays caused by an increase in traffic volume for a time period following the event. Furthermore, the route engine 80 can predict hazards caused by social norms at the given event. For instance, if the given event is a sporting event or a concert, the may be an increase in a chance of a hazard due to substance consumption. Conversely, if the given event is a family oriented event, there may be a decrease in the chance of hazards due to proximity of children.

Still further, the route engine 80 can determine predictive influences caused by an unrelated road segment. For instance, if a significant number of accidents are reported in the traffic data, the route engine 80 can determine that there is an increase in the likelihood of a delay along road that are directly or indirectly connected to hospitals. Yet further still, the route engine 80 can determine predictive influences caused by crime related activity. For example, the route engine 80 can be configured to avoid travel routes that travel through areas with historically high crime rates and/or areas where a crime is in progress or has recently been committed. Thus, if a crime rate (either historical or real-time) for a given route of the plurality of travel routes is above a predetermined threshold value, the route engine 80 can remove the given route from the plurality of travel routes so as to reduce the risk to the safety of the user of the end-user device 54.

Additionally, in some examples, the route engine 80 can consider any priority weight given to a particular stop during travel to a destination. For instance, if the route request indicates that a particular stop must take place at a particular time (e.g., to facilitate picking-up of a passenger at a specified time), the route engine 80 can determine a route that best fits the priority weights.

The route engine 80 can determine route data for each of the plurality of travel routes. The route data can include, for example, the minimum travel time for each of the plurality of travel routes as well as the predicted travel time for each of the plurality of travel routes. The route data can also include a confidence value for each of the plurality of travel routes that characterizes a likelihood that the predicted travel time will be accurate or nearly accurate. For instance, if the predicted travel time for a given travel route is based on a determination that an accident has already occurred along the given travel route, there is a high degree of confidence that the predicted delays related to that traffic accident are accurate. Thus, in such a situation, there could be an increase in the confidence value for the predicted travel time for the given route. Conversely, if the predicted travel time for a given route is based on a delay induced by a predicted instance of severe weather (e.g., due to historical data in the weather data), while real-time data in the weather indicates that the weather is relatively mild (e.g., there is a contradiction), the route engine 32 can determine that there is a lower degree of confidence that the predicted travel time for the given route is accurate.

The knowledge-based system 62 can return the route data to the navigation system 60. The navigation system 60 can verify the route data and provide the route data to the end-user device 54 in response to the travel route request. The route data can include, for example, data characterizing each of the plurality of travel routes (e.g., turn-by-turn instructions), as well as the minimum travel time, the predicted travel time and confidence value for the predicted travel time for each of the plurality of travel routes. The GUI 56 can output data characterizing the route to the user for each of the plurality of travel routes, or some subset thereof.

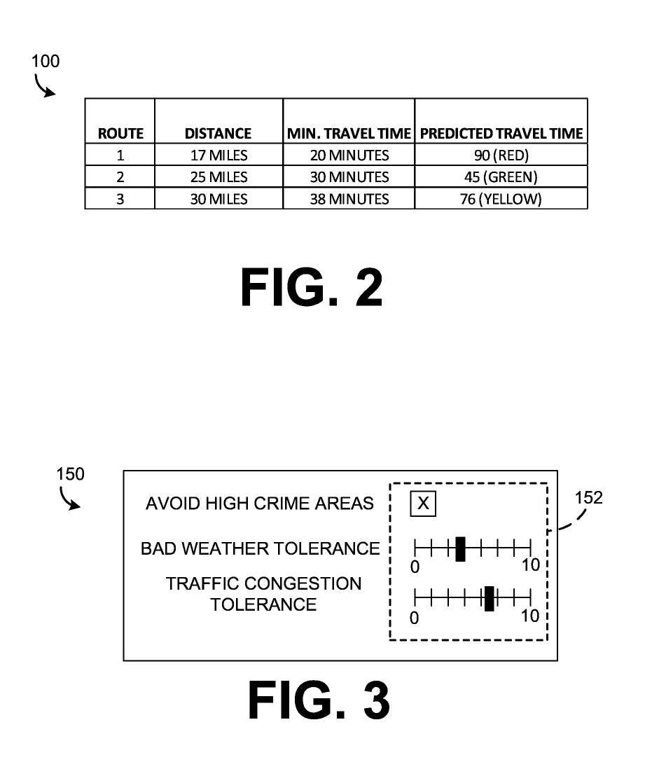

FIG. 2 illustrates an example of an output screen 100 that could be displayed at the GUI 56 of the end-user device 54. The output screen 100 can include a list of travel routes (Routes 1, 2 and 3), along with each respective route's distance. The distance of the route can be, for example, a total travel distance along an associated route. The output screen 100 can also include a minimum travel time characterized in the route data for each of the plurality of travel routes. The output screen 100 can further include a predicted travel time included in the travel data for each respective route. Additionally, the GUI 56 can set a visual indicator for the predicted travel time for each respective route that characterizes the confidence value for the predicted travel time as well as the difference between the minimum travel time and the predicted travel time. The visual indicator could be, for example, a coloring of text (or another indicator, such as an icon). For instance, in the example of the output screen 100 illustrated in FIG. 2, the predicted travel time for Route 1 could be displayed in red, which could indicate that there is a high degree of likelihood that the predicted travel time is correct, and that the predicted travel time is significantly greater than the minimum travel time for Route 1 (4.5 times greater), thereby discouraging the user from selecting Route 1. In this manner, the route data for Route 1 could indicate that Route 1 should take 20 minutes, but it is highly likely that Route 1 could take 90 minutes.

Similarly, the predicted travel time for Route 2 could be displayed in green which could indicate that there is also a high degree of likelihood that the predicted travel time is accurate, and the predicted travel time is not significantly longer than the minimum travel time (1.5 times greater), thereby encouraging the user to select Route 2. In this manner, the route data for Route 2 could indicate that Route 2 should take 30 minutes, but there is a small chance that Route 2 could take 45 minutes. Accordingly, a user of the end-user device 54 may be inclined to select Route 2 instead of route 1, even though Route 2 has a larger travel distance. Additionally, the predicted travel time for Route 3 could be displayed in yellow which could indicate that there is a medium degree of likelihood that the predicted travel time is accurate and the predicted travel time is about twice the minimum travel time.

It is to be understood that there are numerous other ways that the route data could be output to the user. For example, in some situations, the route data could be displayed on a map and/or in text form. Upon selection of the route (e.g., by touching or other user input), a navigation process can begin such that turn-by-turn directions can be provided to the user in real-time (or near real time).

Referring back to FIG. 1, the selection of the route can cause the selected route to be provided to the navigation system 60 that can forward the selection to the knowledge-based system 62 as feedback data that can be employed for future predictions of travel times. Additionally or alternatively, in some situations, the knowledge-based system 62 can determine that real-time changes to traffic and/or weather conditions occurring while traveling along a given route (or when starting the given route) of the plurality of travel routes significantly changes a predicted travel time and/or an associated confidence value. Such changes could include accidents, weather changes, construction delays, unexpected traffic volumes, flooded roads, etc. In such a situation, the navigation system 60 can receive alerts from the knowledge-based system 62, and these alerts can be pushed to the navigation application 52 of the end-user device 54, and the GUI 56 can be updated to reflect the alerts.

Furthermore, in some examples, the user may request a route and timeframe for traveling to the destination. For instance, the user can employ the GUI 56 to provide a window of travel time to the destination. In such a situation, the route engine 80 of the knowledge-based system 62 can determine the route data for each of the plurality of travel routes for a plurality of different timeframes that characterize a time of leaving the starting position (or other position). For instance, if the user is planning an extended trip (e.g., a vacation) to the destination (e.g., a beach), and the user is flexible on the time to leave for the destination, the timeframes for each of the plurality of travel routes can be employed by the route engine 80 to determine which leaving time (e.g., starting time) has the lowest predicted travel time.

Employment of the system 50 can reduce the inconveniences of delays and/or hazards associated with travel. For example, the navigation application 52 can be implemented, on fleet vehicles, (e.g., delivery vehicles), emergency vehicles (e.g., police cars, fire trucks and/or ambulances), as well as private vehicles and/or autonomous vehicles. Moreover, due to the unpredictable nature of delays and/or hazards related to travel, users of the end-user device 54 may employ the navigation application 52 and the GUI 56 on a daily basis (e.g., to drive to work). In such a situation, as the number of users employing the system 50 increases, more users would adjust driving and/or select travel routes that provides feedback data to the knowledge-based system 62 that would further strengthen the confidence values associated with predicted travel times. Additionally, the knowledge-based system 62 and/or the route engine 80 can predict (due to multiple selections of a particular route) increased traffic in a particular area, and limit the number of users that are routed through the area. Furthermore, as more users adjust their driving conditions, traffic patterns could be influenced, such that traffic congestion could be reduced, thereby increasing the efficiency of existing road structure.

FIG. 3 illustrates an example of a screen shot 150 from a GUI (e.g., the GUI 56) of a navigation application (e.g., the navigation application 52) that facilitates the setting and changing of user preferences. The screenshot 150 can include a set of user controls 152. The user controls 152 can include, for example, radio buttons, checkboxes, sliding scales, etc. In the screenshot 150, a user preference related to “AVOID HIGH CRIME AREAS” can have a check box indicating whether the user wishes to avoid high crime areas during travel (whenever possible) at the expense of travel time. Additionally, in the screenshot 150, the user can select a user preference related to “BAD WEATHER TOLERANCE”. For instance, the user can employ a sliding scale to indicate a degree to which the user would sacrifice travel time to avoid driving in inclement weather conditions (e.g., from ‘0’ to ‘10’). This particular user preference could be employed for long distance trips, where multiple travel routes to the same destination may experience different weather patterns. Furthermore, in the screenshot 150, the user can select a user preference related to “TRAFFIC CONGESTION TOLERANCE”. For example, the user can employ another sliding scale to indicate a degree with which the user would sacrifice travel time to avoid driving in congested areas. It is to be understood that in other examples, other user preferences could be employed.

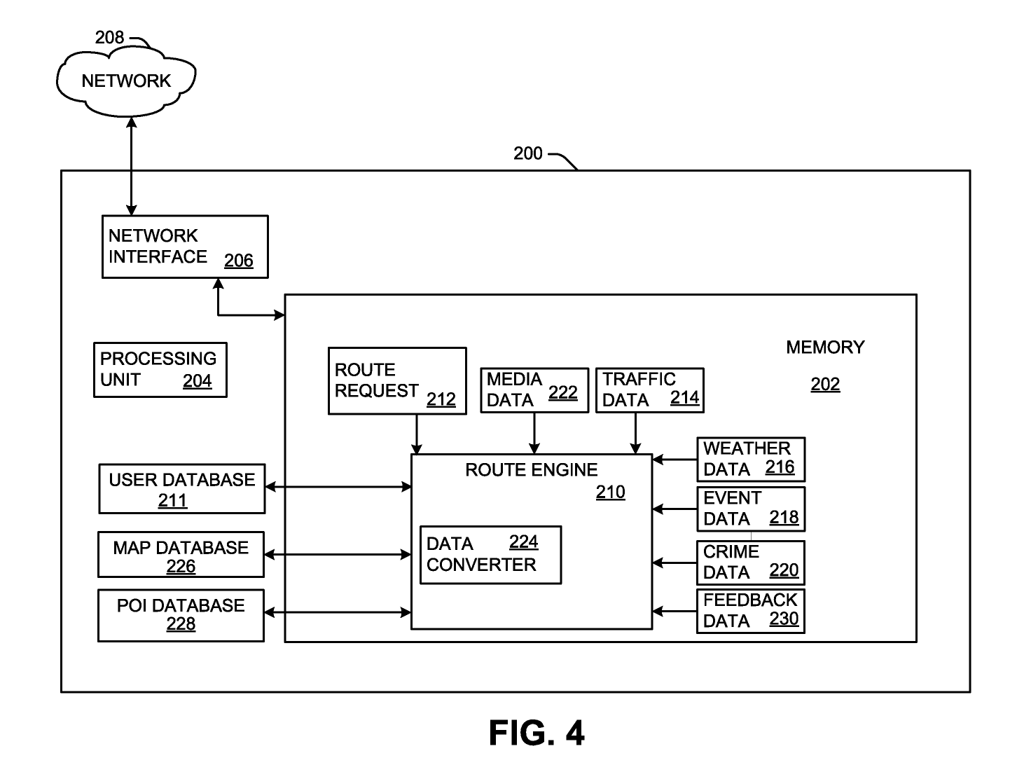

FIG. 4 illustrates an example of a knowledge-based system 200 that could be employed, for example, as the knowledge-based system 62 illustrated in FIG. 1. The knowledge-based system 200 can include a memory 202 that can store machine readable instructions. The memory 202 could be implemented, for example, as non-transitory computer readable media, such as volatile memory (e.g., random access memory), nonvolatile memory (e.g., a hard disk drive, a solid state drive, flash memory, etc.) or a combination thereof. The knowledge-based system 200 can also include a processing unit 204 to access the memory 202 and execute the machine-readable instructions. The processing unit 204 can include, for example, one or more processor cores. The knowledge-based system 200 can include a network interface 206 configured to communicate with a network 208. The network interface 206 could be implemented, for example, as a network interface card. The network 208 could be implemented for example, as a public network (e.g., the Internet), a private network (e.g., a carrier network) or a combination thereof.

The knowledge-based system 200 could be implemented, for example in a computing cloud. In such a situation, features of the knowledge-based system 200, such as the processing unit 204, the network interface 206, and the memory 202 could be representative of a single instance of hardware or multiple instances of hardware with applications executing across the multiple of instances (i.e., distributed) of hardware (e.g., computers, routers, memory, processors, or a combination thereof). Alternatively, the knowledge-based system 200 could be implemented on a single dedicated server.

The knowledge-based system 200 can include a route engine 210. The route engine 210 can be implemented, for example, as an artificial intelligence system/engine that can process natural language, such as the IBM Watson® system. In other examples, the knowledge-based system 62 can be implemented as a belief network (e.g., a Bayesian network), a decision tree, an ensemble learning algorithm (e.g., a random forest), a neural network, logistical regression, a support vector machine, a naive Bayes classifier, a combination thereof, etc. The route engine 210 (and/or other portions of the knowledge based system 200) can be implemented in a manner illustrated and described with respect to FIG. 9.

The route engine 210 can receive a route request 212 that is generated at a navigation application executing on an end-user device. In some examples, the route request 212 can be provided from a navigation system via the network 208. In other examples, features of the navigation system and the knowledge-based system 200 can be combined, and the route request 212 can be provided via the network 208 from the navigation application executing on the navigation application. The route request 212 can include user preferences, such as the user preferences 150 illustrated in FIG. 3. For purposes of simplification of explanation, it is presumed that the features of the navigation system are integrated with the knowledge-based system 200, but in other examples, it is to be understood that some (or all) of the operations described with respect to the knowledge-based system 200 could be implemented on the navigation system. The route request 212 can include, for example, a current location of the end-user device executing the navigation application. Additionally, the route request 212 can include a unique identifier (e.g., a media access control (MAC) address or other network address) for the end-user device and/or a unique identifier for a user of the end-user device (e.g., a username).

The route engine 210 can access a user database 211 (or other data structure) to derive information about the user of the end-user device. In some examples, the user database 211 can include data characterizing a user's home address, a work address, etc. The route engine 210 can receive environmental data (e.g., as feeds) from a plurality of sources via the network 208. The environmental data can characterize environmental conditions that can affect traffic flow of an area. For instance, the route engine 210 can receive traffic data 214 that characterizes traffic patterns for a particular geographic area. Additionally, the route engine 210 can receive weather data 216 that characterizes weather conditions (e.g., both current and future predicted weather conditions) for a geographic area. Further, the route engine 210 can receive event data 218 that characterizes community events (e.g., sporting events, concerts, etc.) in a geographic area. Still further, the route engine 210 can receive crime data 220 that characterizes crime statistics of a geographic area (e.g., violent crime, identity theft, etc.). In some examples, the route engine 210 can receive media data 222 (e.g., Twitter® feeds, news feeds, etc.). The media data 222 can characterize real-time, past or future events that may affect traffic flow. The various forms of the environmental data can be implemented, for example, as natural language (e.g., English text), structural data, statistical data or any combination thereof. In some situations, the route engine 210 can include a data converter 224 that can convert the environmental data into a format employable by the route engine 210.

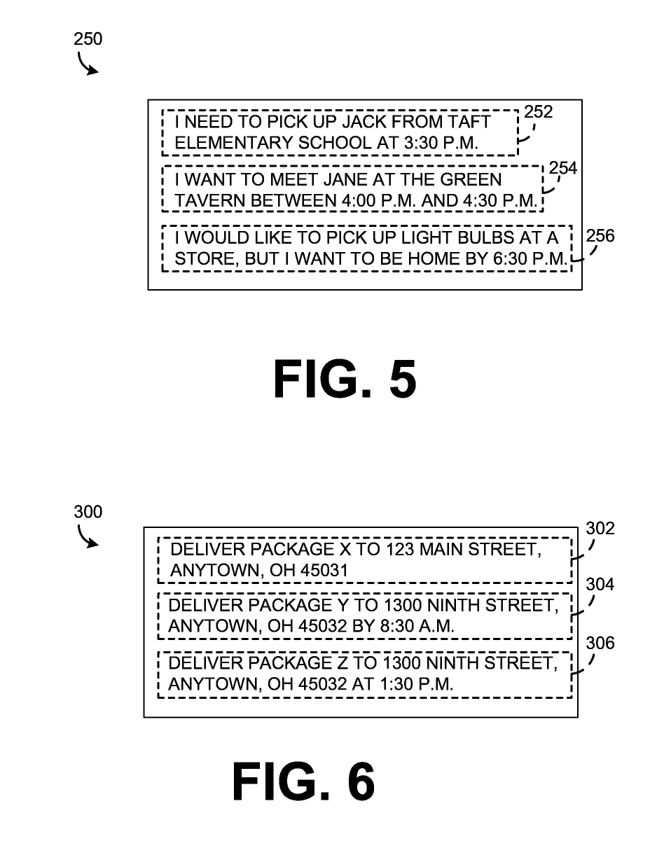

In a first extended example, (hereinafter, “the first example”), the route request 212 can be based on input data 250 illustrated in FIG. 5. In FIG. 5, the input data 250 can be implemented as natural language (e.g., English Text). The input data 250 can be generated, for example, in response to user input (e.g., speech, text, etc.). The input data 250 can be input into a navigation application (e.g., the navigation application 52 of FIG. 1) to generate the route request 212.

The input data 250 can include 3 different text portions, a first text portion 252, a second text portion 254 and a third text portion 256. It is noted that the terms “first”, “second” and “third” do not necessarily indicate a temporal relationship between each of the text portions. Moreover, each of the first text portion 252, the second text portion 254 and the third text portion 256 can be input at different times and/or after a route has already begun.

The first text portion 252, which reads in FIG. 5 as, “I NEED TO PICK UP JACK FROM TAFT ELEMENTARY SCHOOL AT 3:30 P.M.” could indicate that there is a high urgency for the user to be at the Taft Elementary School at 3:30 p.m. Additionally, the second text portion 254, which reads in FIG. 5 as, “I WANT TO MEET JANE AT THE GREEN TAVERN BETWEEN 4:00 P.M. AND 4:30 P.M.” could indicate that there is a medium level of urgency for the user to be at Green Tavern between 4:00 p.m. and 4:30 p.m. Furthermore, the third text portion 256, which reads in FIG. 5 as, “I WOULD LIKE TO PICK UP LIGHT BULBS AT A STORE, BUT I WANT TO BE HOME BY 6:30 P.M.” could indicate that there is a low level of urgency for the user to be at a point of interest (POI) that sells light bulbs prior to a sufficient time to travel a home of the user by 6:30 p.m.

Referring back to FIG. 4, the route engine 210 can process the route request 212 and access a map database 226 (or other data structure) to identify a location and an order of each stop needed to determine a full route (referred to as a travel route) for the end-user device. Moreover, the route engine 210 can determine multiple instances of such travel routes with different orders of stops and/or travel routes that employ an alternate road. In the first example, the route engine 312 can process the first text portion 252 to (i) determine the location of Taft Elementary School and (ii) determine that there is a high priority associated with being at Taft Elementary School as close as possible to 3:30 p.m. Additionally, the route engine 210 can process the second text portion 254 and to determine (i) the location of Green Tavern and (ii) that there is a medium priority associated with being at Green Tavern at any time between 4:00 p.m. and 4:30.

Further, in the first example, the route engine 210 can process the third text portion 356, but the third text portion 356 does not specify any particular POI (e.g., retail establishment) from which light bulbs can be purchased. Thus, the route engine 210 can access a map database 226 and/or a POI database 228 that to identify retail establishments that are likely to sell light bulbs. Moreover, in some situations, a POI can be selected based on pre-paid advertisement agreements and/or user preferences (e.g., customer loyalty programs) specified in the routing request 212. Additionally, the third text portion 356 also indicates that the user desires to be home by 6:30 p.m. In some situations, the “home” of the user can be stored in a record of the user database 211 that is associated with the user. In other examples, the route request 212 can include a location of the home of the user (e.g., as an address and/or latitude and longitude coordinates).

Each travel route can be a series of roads that lead the end-user device from a current location to one or more stops and to an ultimate destination (the home of the user of the end-user device, in the first example). Additionally, the route engine 210 can determine a minimum travel time from the current position of the end-user device along each of the travel routes. The minimum travel time can characterize the minimum amount of time needed to legally travel (e.g., drive within speed limits) between the current position of the end-user device during optimal (or near optical) conditions. Such optimal conditions can include, for example, light traffic, good weather, little to no reported crime, no current community events, etc.

In the first example, the route engine 210 can determine an area between a current position of the end-user device and an area around each of the potential four stops and destination, namely, (i) Taft Elementary School, (ii) Green Tavern, (iii) a retail establishment that sells light bulbs and (iv) the home of the user of the end-user device, which area can be referred to as a travel area. In some examples, the route engine 210 can process the traffic data 214, the weather data 216, the event data 218, the crime data 220 and/or the media data 222 to determine weather, event schedules and/or crime statistics for the travel area to determine a plurality of travel routes for the end-user device. Moreover, in some examples, the route engine 210 can query sources via the network 208 to determine such information for the travel area.

Further, the route engine 210 can determine a predicted travel time for each of the travel routes. The route engine 210 can aggregate the traffic data 214, the weather data 216, the event data 218, the crime data 220 and/or the media data 222 to determine the predicted travel time for the plurality of travel routes. The predicted travel time can represent a travel time that accounts for a plurality of predictive influences to traffic patterns, weather, local events, feedback, etc. Additionally, the route engine 210 can remove a travel route from the plurality of travel routes if the travel route exceeds constraints set forth in user preferences (e.g., high crime area, excessive traffic congestion, etc.).

The predictive influences can cause predictable delays, predictable hazards and/or predictable avoidance areas along a given travel route of the plurality of travel routes. For instance, historical and/or real-time accident and/or traffic volume characterized in the traffic data 214 can be employed by the route engine 210 to determine predictable delay times caused by traffic for times near the time that the travel route request is provided by the navigation system 4. Additionally, the route engine 210 can employ the event data 218 to determine predictable delays related to a given community event. For instance, the route engine 210 can predict delays caused by an increase in traffic volume for time period leading up to the given community event. Additionally, the route engine 210 can predict hazards caused by people that are running late to the given event (e.g., due to speeding). Furthermore, the route engine 210 can estimate delays caused by an increase in traffic volume for a time period following the given event. Furthermore, the route engine 210 can predict hazards caused by social norms at the given event. For instance, if the given event is a sporting event or a concert, the may be an increase in a chance of a hazard due to substance consumption. Conversely, if the given event is a family oriented event, there may a decrease in the chance of hazards due to proximity of children.

Additionally, the route engine 210 can constantly monitor a real-time status of the social event. For example, in situations where the social event is a sporting event, the real-time score and time (e.g., time remaining) of the game can be indicative of an increase or decrease of traffic congestion. For instance, in a closely contested game (e.g., the score is tied or nearly tied) the route engine 210 can predict that there will be increased traffic congestion after a predicted time of an end of the game. Conversely, in a game with a large score differential (often informally referred to as a “blow-out”), the route engine 210 can predict an increase of traffic at a particular time during the game (e.g., the start of the fourth quarter of the game).

Additionally or alternatively, the route engine 210 can employ an inference engine to determine predictive influences caused by an unrelated road segment. For instance, if a significant number of accidents are reported in the traffic data, the route engine 210 can determine that there is an increase in the likelihood of a delay along road that are directly or indirectly connected to hospitals. Yet further still, the route engine 210 can determine predictive influences caused by crime related activity. For example, the route engine 210 can be configured to avoid travel routes that travel through areas with historically high crime rates and/or areas where a crime is in progress or has recently been committed.

Still further, the route engine 210 can receive (or derive) feedback data 230 that characterizes historical and/or real time selection of travel routes. The feedback data 230 can be employed by the route engine 210 as yet another predictive influence of the predicted travel time for each of the plurality of travel routes. For example, if the feedback data 230 indicates that a sufficient number of end-user devices are traveling along a particular road at a particular time, the route engine 210 may determine that the particular road is likely to be congested in the future, even if the current traffic data 214 indicates that there is currently light traffic on the particular road. In this manner, as more and more navigation applications employ the knowledge-based system 200, the more accurate the route engine 210 can be in predicting the travel times. Furthermore, the route engine 210 can also determine a confidence value for each of the predicted travel times of the travel routes. The confidence value can characterize a likelihood that each of the predicted travel times is accurate. In general, the more predictable that the predictive influences are (e.g., less random), the higher the confidence value indicating that the predicted travel time is accurate.

Moreover, returning to the first example, the route engine 210 can re-order the stops between the current location and the final destination based on a current time and a priority given to each stop. For instance, in the first example, if the current is 2:00 p.m. and Taft Elementary School is within a predicted travel time of less than a certain amount (e.g., ½ hour), the route engine 210 may examine the feasibility of ordering the stops such that the stop at the retail establishment is made prior to a stop at Taft Elementary School. In such a situation, the route engine 210 can estimate a predicted travel time for different travel routes that each have the stops along the travel route occur in different orders.

Upon determining optimal and sub-optimal travel routes for each of the stops (or some subset thereof) to the ultimate destination, the route engine 210 can return route data to the navigation application of the end-user device. The route data can also include the predicted travel times for each of the travel routes and the confidence value associated with each of the predicted travel times. The end-user device can provide an option for the user to select a particular travel route, such as in the manner illustrated and described with respect to FIGS. 1 and 2. The selection of the particular travel route can be received as part of the feedback data 230 that can be employed to further increase the accuracy of the predicted travel times in the manner described herein.

In a second extended example, (hereinafter, “the second example”), the route request 212 can be based on input data 300, as illustrated in FIG. 6. In FIG. 6, the input data 300 can be implemented as natural language (e.g., English Text). The input data 300 can be generated, for example, in response to user input (e.g., speech, text, etc.). Additionally, in some instances, the input data 300 can be added by another computer (e.g., automatically). The input data 300 can be input into a navigation application to generate the route request 212.

The input data 300 can include 3 different text portions, a first text portion 302, a second text portion 304 and a third text portion 306. In the second example, the input data 300 can be employed, for instance, in a navigation application being employed by a feet vehicle to determine an efficient time and route to deliver packages.

In the second example, the first text portion 302, which reads, “DELIVER PACKAGE X TO 123 MAIN STREET, ANYTOWN, OH 45031” could indicate that a delivery of “package X” needs to occur sometime during the business day (e.g., prior to 5 p.m.). Additionally, the second text portion 304, which reads, “DELIVER PACKAGE Y TO 1300 NINTH STREET, ANYTOWN, OH 45032 BY 8:30 A.M.” can indicate that a delivery of “package Y” needs to occur by 8:30 A.M. Furthermore, the third portion, which reads, “DELIVER PACKAGE Z TO 1300 NINTH STREET, ANYTOWN, OH 45032 AT 1:30 P.M.” can indicate that a delivery of “package Z” needs to occur at (or near) 1:30 p.m.

In the second example, the route engine 210 can employ an inference engine to process the route request 212 and weigh the predictive influences in the manner described herein, to determine a travel route and an order of the stops, as well a predicted travel time from a current location of the end-user device (employed in the delivery vehicle) along the travel routes that includes each of the stops. Additionally, in the second example, the route engine 210 may apply a constraint (e.g., user preferences) on the travel route. For instance, some delivery services may have a policy of not making left-hand turns unless necessary. Thus, in such a situation, the route engine 210 can apply this constraint when determining the travel route and/or the predicted travel time. In some situations, the route engine 210 may only provide one possible travel route, and in other examples, the route engine 210 can provide a plurality of travel routes, wherein the user can select a preferred travel route in the manner described with respect to the first example.

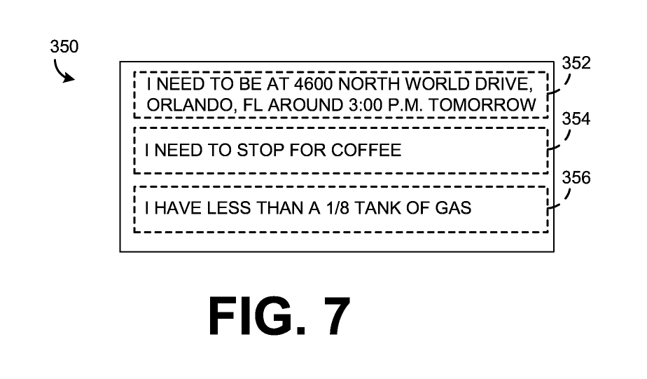

In a third extended example, (hereinafter, “the third example”), the route request 212 can be based on input data 350 illustrated in FIG. 7. In FIG. 7, the input data 350 can be implemented as natural language (e.g., English Text). The input data 350 can include 3 different text portions, a first text portion 352, a second text portion 354 and a third text portion 356. In the third example, the input data 350 can be employed, for example in a navigation application being employed by a vehicle traveling a relatively large distance (e.g., 1000+ miles) on a vacation.

In the third example, the first text portion 352, which reads “I NEED TO BE AT 4600 NORTH WORLD DRIVE, ORLANDO, FL AROUND 3:00 P.M. TOMORROW” could that the end-user device has a flexible starting time for travel and that the arrival time (around 3:00 P.M.) at the destination is also flexible. Additionally, the second text portion 354, which reads “I NEED TO STOP FOR COFFEE” can indicate a desire of the user to be directed to a retail facility that serves coffee. Furthermore, the third text portion 356, which reads “I HAVE LESS THAN A ⅛ TANK OF GAS” can indicate that the user needs to be directed to a gas station. In the third example, it is presumed that the second text portion 354 and the third text portion 356 are provided after the end-user device is on route to the final destination, namely 4600 North World Drive, Orlando, Fla.

In the third example, the route engine 210 can employ an inference engine to process the route request 212 and weigh the predictive influences in the manner described herein, to determine a plurality of travel routes to the final destination that arrives at a time around 3:00 p.m. the day after a current day. In the third example, since the travel distance is large (e.g., 1000+ miles) the route engine 210 can analyze the plurality of different travel routes that deviate based on predicted weather patterns. Moreover, in the third example, the route engine 210 can estimate a predicted travel time (and associated confidence value) for each of plurality of travel routes to the final destination, along with a suggested start time for each of the plurality of travel routes. The travel routes, the predicted travel times and associated confidence values can be provided to the navigation application as route data. In this manner, a user of the end-user device can select a chosen route, and feedback data 230 characterizing the selection can be received by the route engine 210.

Furthermore, in the third example, while on-route to the final destination, the second text portion 354 of the input data 350 can be received by the route engine. In such a situation, the route engine 210 can access the map database 226 and the POI database 228 to identify a POI (e.g., a coffeehouse) that serves coffee and impacts the travel time to the final destination as little as possible. Moreover, as noted, the selection of the POI can also be based on loyalty programs (e.g., identified in the user database 211) and/or advertising agreements. Thus, in response to receiving the second text portion 354, the route engine 210 can provide route data that characterizes POIs that serve coffee, as well as a predicted travel time to each of the POIs and a predicted change to the travel time to the final destination. The user can select a particular POI and the selection can be received and processed as feedback data 230 in the manner described herein.

Still further, in the third example, while on-route to the final destination, the third text portion 356 of the input data 350 can be received at the route engine 210. In this situation, the route engine 210 can access the map database 226 and/or the POI database 228 to determine the POI (e.g., a gas station) with the fasted predicted travel time from the current location of the end-user device. In the third example, the indication that the vehicle has less than ⅛ of a tank of gas can supersede other factors, such as loyalty programs, agreed upon advertisements, weather, etc. to ensure that the user reaches the gas station prior to exhausting the fuel supply. In the third example, the route engine 210 can provide the navigation application with route data characterizing a plurality of POIs (e.g., gas stations) as well as the predicted travel time to each POI. The user can select a particular POI, and the route engine 210 can receive and process the selection as feedback data 230 in the manner described herein.

By employment of the knowledge-based system 200, efficient travel routes for end-user devices can be ascertained. Moreover, by applying artificial intelligence in the manner described herein, many different factors, including, but not limited to, weather, crime statistics, media information and traffic can be weighed in determining a route from a current location to a destination, as well as stops along the way. The knowledge-based system 200 can improve efficiency of navigation applications employed, for example, by private individuals, autonomous vehicles, fleet vehicles, emergency services, etc.

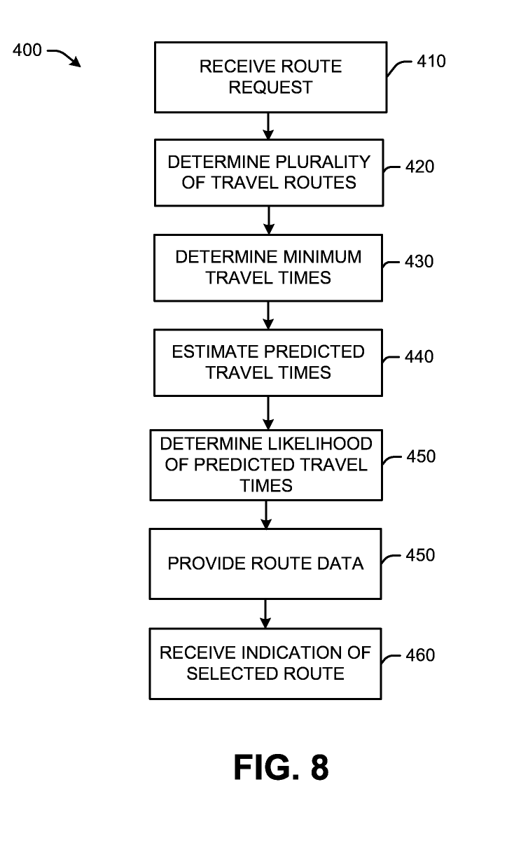

In view of the foregoing structural and functional features described above, example methods will be better appreciated with reference to FIG. 8. While, for purposes of simplicity of explanation, the example method of FIG. 8 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 8 can be implemented as instructions stored in a non-transitory machine-readable medium. The instructions can be accessed by a processing resource (e.g., one or more processor cores) and executed to perform the methods disclosed herein.

FIG. 8 illustrates an example flowchart of a method 400 for determining a travel route for a navigation application executing on an end-user device. The method 400 can be implemented for example, on a navigation system and/or a knowledge-based system, such as the navigation system 60 and knowledge-based system 62 illustrated in FIG. 1 and/or the knowledge-based system 200 illustrated in FIG. 4.

At 410, a route engine (e.g., the route engine 80 of FIG. 1 and/or the route engine 210 of FIG. 4) can receive a route request from the navigation application. The route request can include data (e.g., text) characterizing a request for directions to a specific location (e.g., an address and/or latitude and longitude coordinates). At 420, the route engine can determine a plurality of travel routes from a current location of the end-user device (characterized in the route request) to the destination. At 430, the route engine can determine a minimum travel time to the destination based, for example, on a distance needed to travel to the destination and on a speed limits of streets between the current location and the destination.

At 440, the route engine can employ environmental data, such as traffic data, weather data, event data, crime data, media data, feedback data and/or data from other sources to estimate a predicted travel time to the destination for each of the plurality of travel routes. In particular, the predicted travel time can be based on predictive influences derived from the environmental data. At 450, the route engine can determine the likelihood that the predicted travel times are accurate. At 460, the route engine can provide route data to the end-user device that characterizes each of the plurality of paths (or some subset thereof), as well as a minimum travel time, a predicted travel time and the likelihood that the predicted travel time is accurate. At 470, the route engine can receive an indication of a particular route of the plurality of travel routes that has been selected by the user of the navigation application. The indication of the selection of the particular route can be employed, for example, to augment the feedback data.

FIG. 9 illustrates an example of a route engine 500 that could be employed to implement the knowledge based system 62 (including the route engine 80) of FIG. 1 and/or the route engine 210 of FIG. 4. The route engine 500 can be representative of a cognitive computing system. The route engine 500 can include a route request analyzer 502 that can implement functions for receiving and analyzing a route request. A candidate travel route generator 504 can be included to search for candidate travel routes by traversing structured, semi structured and/or unstructured sources contained in traffic influence sources 506 and/or in an Answer Source Knowledge Base 508 (e.g., including map data) containing collections of relations and lists extracted from primary sources. The candidate travel route generator 504 can, in some examples, generate hundreds or thousands of different candidate travel routes for the route request that vary, for example, by roads taken to get to a destination, an order and/or number of stops taken to get to the destination, etc. The traffic influence sources 506 can include data collected from traffic data, weather data, crime data, feedback data, media data, etc., in a manner described herein. Each of the sources of information can be locally stored and/or distributed over a network, including the Internet. The candidate travel route 30 can generate a plurality of output data structures containing candidate travel routes based upon the analysis of retrieved data.

In one example, an Evidence Gathering module 510 can include a supporting passage retriever 512 and a candidate travel route scorer 514 that interface with the traffic influence sources 506 and the answer source knowledge base 508 for concurrently analyzing evidence (e.g., parallel operations) based on passages having candidate travel routes (e.g., which can include different orders of stops to a destination), and the candidate travel route scorer 514 scoring each candidate travel route as parallel processing operations. In one example, the architecture may be employed utilizing the Common Analysis System (CAS) candidate answer structures, and implementing the Supporting Passage Retriever 512. The Answer Source Knowledge Base 508 may include one or more databases of structured or semi-structured sources (pre-computed or otherwise) that each include collections of relations (e.g., Typed Lists). In some examples, the Answer Source knowledge base 508 can include a database stored in a non-transitory machine readable medium. The supporting passage retriever 512 and the candidate travel route scorer 514 can determine a minimum travel time for each travel route (e.g., driving in near optimal conditions) and a predicted travel time for each travel route.

A travel route ranking and confidence value module 516 can provide functionality for ranking candidate travel routes (e.g., on a predicted travel time) and determining a confidence value for a predicted travel time of the travel routes. A subset of the highest ranking (e.g., top three) travel routes and associated confidence values for predicted travel times (along with a minimum travel time) can be returned to an end-user device (directly or indirectly) that provided the travel route request. The ranking and/or the confidence value can be based, for example, on a determined reliability of the sources for the predicted travel time of each travel route. The subset of travel routes can be output as a list of travel routes, and a corresponding minimum travel time, predicted travel time and associated confidence values of the predicted travel time in a manner illustrated and described with respect to FIG. 2.

The processing depicted by the route engine 500, may be local, on a server, or server cluster (e.g., a computing cloud), within an enterprise, or alternately, may be distributed with or integral with or otherwise operate in conjunction with a public or privately available search engine in order to enhance the question answer functionality in the manner as described. Thus, the route engine 500 can be provided as a computer program product comprising instructions executable by a processing device, or as a service deploying the computer program product. The architecture employs a search engine (a data retrieval system) as a part of the candidate travel route generator 504 which may be dedicated to the Internet, a publicly available database, a web-site, a social media site or a privately available database. Databases can be stored in any storage system, e.g., a hard drive, a solid state drive or flash memory, and can be distributed over the network or can be locally stored.

As mentioned, the route engine 500 can employ the Common Analysis System (CAS), a subsystem of the Unstructured Information Management Architecture (UIMA) can handle data exchanges between the various UIMA components, such as analysis engines and unstructured information management applications. CAS supports data modeling via a type system independent of programming language, provides data access through a powerful indexing mechanism, and provides support for creating annotations on text data. It is noted that the CAS allows for multiple definitions of the linkage between a feed and a feed's annotations, as is useful for the analysis of images, video, or other non-textual modalities.

In one example, the UIMA may be provided as middleware for the effective management and interchange of unstructured information over a wide array of information sources. The architecture generally includes a search engine, data storage, analysis engines containing pipelined feeds annotators and various adapters. The UIMA system, method and computer program may be used to generate travel routes to input queries. The method includes inputting a feed and operating at least one text analysis engine that comprises a plurality of coupled annotators for tokenizing feed data and for identifying and annotating a particular type of semantic content. Thus, the UIMA can be used to analyze a question and to extract entities as possible answers to a question from a collection of feeds and/or documents.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, solid-state storage devices, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A non-transitory machine readable medium having machine executable instructions comprising a route engine, the route engine being configured to:
receive route data that characterizes a request for driving directions to a destination;
determine a plurality of travel routes to the destination;
estimate a predicted travel time for each of the plurality of travel routes to the destination, wherein the estimation is based on predictive influences derived from environmental data that characterizes environmental conditions that affect traffic flow along the plurality of travel routes; and
determine a likelihood that each predicted travel time for each of the plurality of travel routes is accurate.

2. The medium of claim 1, wherein the route engine is further configured to:
provide route data that characterizes (i) the plurality of travel routes, (i) a determined minimum travel time for each of the plurality of travel routes and (ii) the likelihood that the predicted travel time for each of the plurality of travel routes is accurate.

3. The medium of claim 1, wherein the environmental data characterizes at least:
current traffic patterns on roads along the plurality of travel routes; and
predicted weather patterns in an area that includes the roads along the plurality of travel routes.

4. The medium of claim 3, wherein the predictive influences include anticipated traffic delays derived from environmental data that characterizes a community event taking place near the roads along the plurality of travel routes.

5. The medium of claim 3, wherein the environmental data further characterizes at least one of a crime rate for an area near the roads along the plurality of travel routes and a crime in progress near the roads along the plurality of travel routes.

6. The medium of claim 3, wherein the predictive influences include anticipated traffic delays derived from environmental data characterizing social media information corresponding to environmental conditions in an area near the roads along the plurality of travel routes.

7. The medium of claim 3, wherein the predictive influences includes future predicted traffic patterns based on environmental data characterizing feedback from multiple selections of particular travel routes.

8. The medium of claim 1, wherein the determination of the plurality of travel routes is based on user preferences characterized in the route request.

9. The medium of claim 8, wherein the user preferences characterize a preference to avoid high crime rate areas.

10. The medium of claim 8, wherein the user preferences characterize a tolerance for inclement weather.

11. The medium of claim 8, wherein the user preferences a tolerance for traffic congestion.

12. The medium of claim 1, wherein the route data characterizes a plurality of stops prior to arrival at the destination.

13. The medium of claim 12, wherein the plurality of travel routes characterizes travel directions to the stops in different orders.

14. The medium of claim 1, wherein the route request comprises natural language that characterizes a level urgency of prompt arrival at the destination.

15. The medium of claim 14, wherein the route engine is further configured to determine a start time for each of the plurality of travel routes.

16. The medium of claim 1, wherein the route engine is further configured to determine a minimum travel time for each of the plurality of travel routes, wherein the minimum travel time is based on a travel distance and a speed limit along roads of each of the plurality of travel routes.

17. A knowledge-based system comprising one or more computing devices, the knowledge-based system being configured to:
determine a travel route from a current location of an end-user device to a destination;
determine a minimum travel time for the travel route based on a distance of the travel route and on speed limits of roads along the travel route;
estimate a predicted travel time for the travel route based on the minimum travel time and on predictive influences derived from environmental data that characterizes environmental conditions affecting traffic flow along roads of the travel route; and
provide route data that characterizes the travel route to a navigation application executing on the end-user device.

18. The knowledge base system of claim 17, wherein the travel route comprises a plurality of stops between the current location of the end-user device and the destination, wherein a given stop of the plurality of stops is selected based on at least one of a loyalty program associated with a user of the end-user device and an advertisement agreement associated with a retail establishment at the given stop.

19. The knowledge base system of claim 17, wherein the environmental data characterizes a current traffic pattern, a weather pattern, a crime rate and a community event for an area that includes a portion of the travel route.

20. A method comprising:
determining a plurality of travel routes to a destination in response to a route request;
determining a minimum travel time for each of the plurality of travel routes;
estimating a predicted travel time for each of the plurality of travel routes based on predictive influences derived from environmental data that characterizes environmental conditions affecting the travel time; and
determining a likelihood that each predicted travel time for the plurality of travel times is accurate.
